(19) United States
(12) Patent Application Publication
(10) Pub. No.: US 2011/0007104 A1
(43) Pub. Date: Jan. 13, 2011

(54) LIGHTING DEVICE AND DISPLAY DEVICE HAVING THE SAME

(76) Inventors: Ken Nakazawa, Osaka (JP); Manabu Yamamoto, Osaka (JP); kohji Fujiwara, Osaka (JP); Shinya Okuda, Osaka (JP)

Correspondence Address: BIRCH STEWART KOLASCH & BIRCH, PO BOX 747, FALLS CHURCH, VA, 22040-0747, US

(21) Appl. No.: 12/920,977

(22) PCT Filed: Mar. 3, 2009
(86) PCT No.: PCT/JP2009/053943

§ 371 Date: Sep. 3, 2010

(30) Foreign Application Priority Data
Mar. 7, 2008 (JP) 2008-057887

(51) Int. Cl. G09G 5/10; H05B 37/03

(52) U.S. Cl. 345/690; 315/130

(57) ABSTRACT

There is provided a lighting device that can reduce the occurrence of both color irregularity and brightness irregularity of light to be irradiated onto an irradiation surface even if one of a plurality of light-emitting elements included in light sources fails to light properly, and a display device using this lighting device. The lighting device includes a plurality of light sources (8), each having a plurality of light-emitting elements (26) of different luminescent colors, arranged on a plane, and can control color and luminance of light to be irradiated from the light sources (8) by controlling brightness of each of the light-emitting elements (26) based on a light source driving signal. The device includes: a lighting failure detecting portion (23) that detects which of the light-emitting elements (26) fails to light properly; an emission correction determining portion (34) that determines the necessity of brightness correction for the light-emitting elements (26) other than the light emitting element (26) that fails to light properly, based on a level of the brightness instructed for the light-emitting element (26) that fails to light properly by the light source driving signal; and an emission correcting portion (35) that performs the brightness correction for the other light-emitting elements in accordance with the determination made by the emission correction determining portion (34).

### TECHNICAL FIELD

The present invention relates to a lighting device including a plurality of light sources, each having a plurality of light-emitting elements, arranged on a plane, and a display device using the lighting device as a backlight. In particular, the present invention relates to a lighting device that is less likely to cause color irregularity and brightness irregularity of light to be irradiated from light sources even if a light-emitting element fails to light properly, and a display device having the same.

### BACKGROUND ART

In recent years, a liquid crystal display device characterized by low power consumption, thinness, light weight, and the like has been used widely as a display device for television receivers and the like. A liquid crystal panel used as a display portion of the liquid crystal display device is a so-called non-light-emitting type display element that does not emit light by itself. Thus, the liquid crystal display device usually includes a plane light-emitting type lighting device called a backlight on the back surface of the liquid crystal panel, thereby displaying an image using light irradiated from the backlight.

The backlight is classified roughly into a direct type and a side light type (also called an edge-light type) depending on the arrangement of a light source with respect to the liquid crystal panel. The direct type backlight has a configuration in which a light source is arranged on the back surface side of the liquid crystal panel, and optical members such as a diffusing plate and a prism sheet are arranged between the light source and the liquid crystal panel, so that uniform plane-shaped light is incident on the entire back surface of the liquid crystal panel. Such a direct type backlight is used suitably in, for example, a large-screen liquid crystal display device for television receivers. Further, as the light source of such a direct type backlight, an LED (Light Emitting Diode) recently is finding increased use in place of a conventionally used CCFT (Cold Cathode Fluorescent Tube) because the LED ensures high color reproducibility and contributes to the simplification of a driving circuit as compared with the CCFT.

In the case of using the LEDs as the light source of the direct type backlight, a plurality of the LED light sources are arranged on a bottom surface of a chassis, which is a component of the backlight, both in the vertical and horizontal directions, thereby realizing uniform plane-shaped light. Further, in the backlight for use in a liquid crystal display device for usual television receivers and the like, which is required to irradiate white light in consideration of the color reproducibility of a display image, the LEDs of three colors of red (R), green (G), and blue (B) are arranged in close proximity to each other or put in one resin package, thereby realizing a white (W) light source.

This indicates that the brightness and luminescent color of the backlight can be controlled locally by adjusting the brightness of the individual LEDs that form the respective light sources, while indicating that a plurality of the LEDs are required. By making positive use of this fact, a so-called active backlight technique has been proposed that adjusts the brightness and coloration of the backlight locally depending on a display image.

As described above, in the backlight using the LEDs, one white light source usually is realized by using the LEDs of the three RGB colors. Accordingly, if an LED of any one of the colors is open and fails to light properly, the relevant light source loses its luminescent color balance and is no longer a white light source, which results in color irregularity of the backlight. In order to avoid this, a technique has been proposed that detects the broken-down LED that fails to light properly and turns off the other LEDs included in the light source having the LED that fails to light properly, in other words, the LEDs forming a white light source along with the LED that fails to light properly (Patent Document 1).

### Patent Document 1: JP 2007-108519 A

### DISCLOSURE OF INVENTION

### Problem to be Solved by the Invention

However, according to the conventional backlight control method, although color irregularity of the backlight can be avoided, another problem arises. That is, since all the LEDs included in the one light source are turned off, light to be irradiated from the corresponding portion of the backlight becomes weak, resulting in brightness irregularity of the backlight. In the backlight that is required to function as a uniform plane-shaped light source, it is necessary to avoid the occurrence of brightness irregularity as a luminance variation, let alone color irregularity. Needless to say, a technique that can avoid both color irregularity and brightness irregularity is necessary.

In view of the above described conventional problem, it is an object of the present invention to provide a lighting device that can avoid the occurrence of both color irregularity and brightness irregularity of light to be irradiated from a plurality of light sources arranged on a plane even if any one of a plurality of light-emitting elements included in the light sources fails to light properly, and a display device using the lighting device.

### Means for Solving Problem

In order to achieve the above-described object, a lighting device according to the present invention includes a plurality of light sources, each having a plurality of light-emitting elements of different luminescent colors, arranged on a plane, and can control color and luminance of light to be irradiated from the light sources by controlling brightness of each of the light-emitting elements based on a light source driving signal. The device includes: a lighting failure detecting portion that detects which of the light-emitting elements fails to light properly; an emission correction determining portion that determines the necessity of brightness correction for the light-emitting elements other than the light emitting element that fails to light properly, based on a level of the brightness instructed for the light-emitting element that fails to light properly by the light source driving signal; and an emission correcting portion that performs the brightness correction for the other light-emitting elements in accordance with the determination made by the emission correction determining portion.

Further, a display device according to the present invention includes a display portion. The display portion is irradiated with light from the lighting device according to the present invention.

### EFFECTS OF THE INVENTION

According to the present invention, it is possible to reduce color irregularity and brightness irregularity of light to be irradiated from light sources effectively even if a light-emitting element included in the light sources fails to light properly.

Further, by using the lighting device according to the present invention as a backlight that irradiates a display portion with light, it is possible to realize a display device that can display a high-quality image as a result of accurate brightness control that reduces color irregularity and brightness irregularity of a display image effectively even if a light-emitting element included in the light sources of the lighting device fails to light properly.

### BRIEF DESCRIPTION OF DRAWINGS

FIG. 1 is an exploded perspective view of a liquid crystal display device according to an embodiment of the present invention.

FIG. 2 is a block diagram showing a schematic configuration of the liquid crystal display device according to the embodiment of the present invention.

FIG. 3 is a block diagram showing a schematic configuration of a light source driving circuit and a light source connected thereto in a backlight according to the embodiment of the present invention.

FIG. 4 is a partially enlarged view showing a state where the light sources are arranged on a bottom surface of the backlight according to the embodiment of the present invention.

FIG. 5 is a block diagram showing a schematic configuration of a brightness data generating portion of the backlight according to the embodiment of the present invention.

FIG. 6 is a flowchart showing an operation of brightness correction in the backlight according to the embodiment of the present invention.

FIGS. 7A and 7B are image views for explaining the concept of defining a brightness correction amount in the backlight according to the embodiment of the present invention.

FIGS. 8A to 8C are image views illustrating an effect of the brightness correction in the backlight according to the embodiment of the present invention.

FIG. 9 is a circuit configuration diagram showing a wiring state of LEDs as light-emitting elements of the backlight according to the embodiment of the present invention.

### DESCRIPTION OF THE INVENTION

A lighting device according to the present invention includes a plurality of light sources, each having a plurality of light-emitting elements of different luminescent colors, arranged on a plane, and can control color and luminance of light to be irradiated from the light sources by controlling brightness of each of the light-emitting elements based on a light source driving signal. The device includes: a lighting failure detecting portion that detects which of the light-emitting elements fails to light properly; an emission correction determining portion that determines the necessity of brightness correction for the light-emitting elements other than the light emitting element that fails to light properly, based on a level of the brightness instructed for the light-emitting element that fails to light properly by the light source driving signal; and an emission correcting portion that performs the brightness correction for the other light-emitting elements in accordance with the determination made by the emission correction determining portion.

It should be noted that the light-emitting elements other than the light-emitting element that fails to light properly include at least the light-emitting elements other than the light-emitting element that fails to light properly in one of the light sources that has the light-emitting element that fails to light properly, and the light-emitting elements included in the other light sources adjacent to the light source having the light-emitting element that fails to light properly. Further, the emission correction determining portion may determine the necessity of the brightness correction also for the light-emitting elements included in the still other light sources further adjacent to the other light sources adjacent to the light source having the light-emitting element that fails to light properly, and for the light-emitting elements included in the outer light sources further adjacent to the still other light sources.

With this configuration, it is possible to detect the light-emitting element that fails to light properly, and to determine the necessity of the brightness correction for the other light-emitting elements that light properly, based on the level of the brightness instructed for the light-emitting element that fails to light properly by the light source driving signal. Thus, even if one of the light-emitting elements included in the light sources fails to light properly, the other light-emitting elements are not subjected to the brightness correction depending on the level of the brightness required for the light-emitting element that fails to light properly. As a result, it is possible to reduce color irregularity and brightness irregularity of irradiated light as compared with the case where all the light-emitting elements included in the light source having the light-emitting element that is detected to fail to light properly are turned off across the board.

Further, it is preferable that when the level of the brightness instructed for the light-emitting element that fails to light properly by the light source driving signal is not higher than a predetermined threshold value, the emission correction determining portion determines that it is unnecessary to perform the brightness correction for the other light-emitting elements, and the emission correcting portion does not perform the brightness correction for the other light-emitting elements.

With this configuration, when the brightness instructed for the light-emitting element that fails to light properly by the light source driving signal is low, it is judged that the light-emitting element that fails to light properly does not function substantially, i.e., no substantial effect will be caused even if this light-emitting element does not emit light, and accordingly the other light-emitting elements that emit light normally can be used as they are. Thus, even if one of the light-emitting elements included in the light sources fails to light properly, it is possible to reduce color irregularity and brightness irregularity of irradiated light without tuning off the light source having the light-emitting element that fails to light properly.

Further, it is preferable that when the level of the brightness instructed for the light-emitting element that fails to light properly by the light source driving signal is higher than a predetermined threshold value, the emission correction determining portion determines that it is necessary to perform the brightness correction for the other light-emitting elements, and the emission correcting portion turns off the light-emitting elements other than the light-emitting element that fails to light properly in one of the light sources that has the light-emitting element that fails to light properly, and performs the brightness correction for the light-emitting elements included in the other light sources located around the light source having the light-emitting element that fails to light properly.

With this configuration, when the brightness instructed for the light-emitting element that fails to light properly by the light source driving signal is high, the other light-emitting elements included in the light source having the light-emitting element that fails to light properly are turned off, thereby preventing the occurrence of color irregularity of light to be irradiated from this light source. In addition, by performing the brightness correction for the light-emitting elements included in the other light sources located around the light source that does not light, it is possible to reduce brightness irregularity of irradiated light that is caused when the light source having the light-emitting element that fails to light properly does not light.

Further, it is preferable that the emission correcting portion performs the brightness correction for the light-emitting elements included in the other light sources located around the light source having the light-emitting element that fails to light properly by superimposing a brightness component for the light-emitting elements of respective colors at a ratio that allows these light-emitting elements to irradiate light of the same color as that of light to be irradiated from the light source having the light-emitting element that fails to light properly.

With this configuration, light that should have been irradiated from the light source in which all the light-emitting elements are turned off due to the presence of the light-emitting element that fails to light properly can be compensated for by the other surrounding light sources. Thus, it is possible to reduce the occurrence of color irregularity and brightness irregularity of irradiated light effectively.

Further, it is preferable that the emission correcting portion performs the brightness correction for the light-emitting elements included in the other light sources located around the light source having the light-emitting element that fails to light properly such that the brightness component to be superimposed is decreased with increasing distance between the other light sources and the light source having the light-emitting element that fails to light properly.

With this configuration, when the light that should have been irradiated from the light source in which all the light-emitting elements are turned off due to the presence of the light-emitting element that fails to light properly is compensated for with light to be irradiated from the other surrounding light sources, a change in the brightness correction amount for the surrounding light sources can be made smaller, resulting in a smooth change in the luminance of light to be irradiated from the light sources around the light source that does not light. Thus, it is possible to reduce brightness irregularity of irradiated light more effectively.

Further, it is preferable that the predetermined threshold value is a brightness of 0. When the threshold value for determining whether to perform the correction for the other light-emitting elements that emit light normally is a brightness of 0, the other light-emitting elements can be subjected to the brightness correction reliably when color irregularity and brightness irregularity of irradiated light are likely to occur.

Further, it is preferable that the light-emitting elements included in each of the light sources include a red light-emitting element, a green light-emitting element, and a blue light-emitting element, and that the light-emitting elements are light-emitting diodes.

Further, it is preferable that a plurality of at least a part of the light-emitting elements of the same luminescent color included in a plurality of the light sources are connected in series and driven by one current control element.

With this configuration, even if the lighting device includes a large number of the light-emitting elements, it is possible to realize a practical circuit that requires only a small number of current control elements for driving the light-emitting elements.

Further, by adopting various preferable aspects of the above-described lighting device according to the present invention as a lighting device that irradiates a display portion with light, it is possible to obtain a display device that can perform more preferable image display.

Hereinafter, a preferable embodiment of a lighting device and a display device having the same according to the present invention will be described with reference to the drawings. It should be noted that the following description is directed to an example where the display device according to the present invention is a liquid crystal display device for televisions that is provided with a transmission type liquid crystal panel as a display portion, and the lighting device according to the present invention is used as a backlight thereof. However, applications of the present invention are not limited thereto. For example, a semi-transmission type liquid crystal display element can be used as the display portion of the display device according to the present invention. Further, the display device according to the present invention is not limited to the liquid crystal display device for televisions, but can be used for a wide range of applications such as a computer monitor and an information display monitor for use in public institutions such as a station and a museum.

### Embodiment

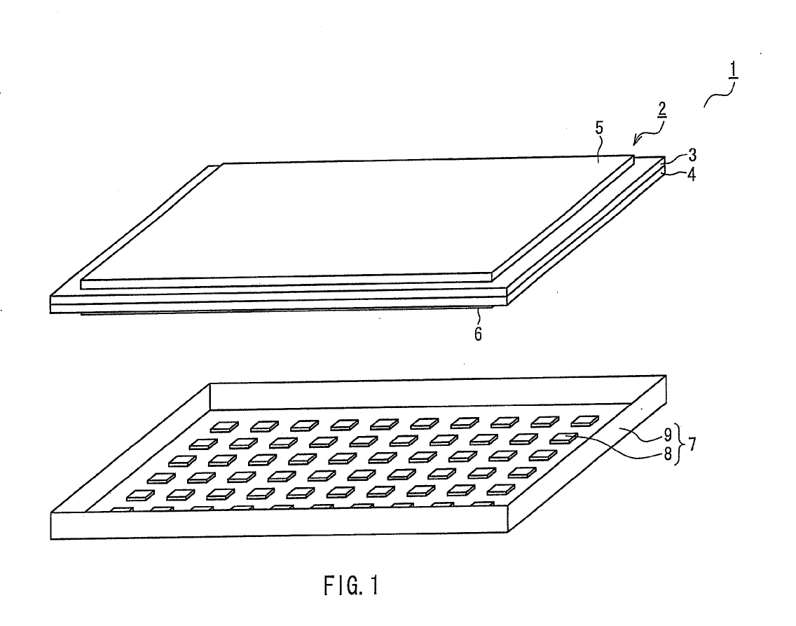

FIG. 1 is an exploded perspective view showing a schematic configuration of a display device according to an embodiment of the present invention. As shown in FIG. 1, a liquid crystal display device 1 according to the present embodiment includes a liquid crystal panel 2 as a display portion, and a backlight 7 as a lighting device that irradiates transmission light required for image display on the liquid crystal panel 2. It should be noted that a video display circuit for performing signal processing for displaying an image, a control circuit for locally adjusting the coloration and brightness of the backlight as an active backlight, a driving circuit, and the like are not shown in FIG. 1.

The liquid crystal panel 2 is a transmission type display element that displays an image by controlling the amount of light to be transmitted through pixels. The type of the liquid crystal panel 2 is not limited particularly as long as multi-gray-scale image display is possible, and may be either an active matrix type using a switching element such as a TFT or a simple matrix type. Further, the liquid crystal panel 2 may be of any of various liquid crystal display modes such as a vertically-aligned (VA) mode type, an IPS type, and an OCB type.

While the liquid crystal panel 2 of the present invention, which may be the same as a conventionally known liquid crystal panel, will not be described in detail with reference to the drawings, it includes a liquid crystal layer not shown, a pair of transparent substrates 3 and 4 that sandwich the liquid crystal layer therebetween, and a pair of polarizing plates 5 and 6 provided respectively on the outer surfaces of the transparent substrates 3 and 4. Further, the liquid crystal panel 2 includes a driver circuit for driving the liquid crystal panel 2, which is connected to the driving circuit of the display device via a flexible printed board or the like.

For example, the liquid crystal panel 2 according to the present embodiment is an active matrix type liquid crystal panel, and is configured to drive the liquid crystal layer on a pixel basis by supplying a scanning signal and a data signal respectively to scanning lines and data lines that are arranged in a matrix form. More specifically, when a switching element (TFT) provided in the vicinity of each of intersections of the scanning lines and the data lines is brought to an ON state based on a signal of a corresponding one of the scanning lines, a data signal is written from a corresponding one of the data lines into a pixel electrode, and an alignment state of liquid crystal molecules changes in accordance with a potential level of the data signal, whereby each pixel performs gray-scale display in accordance with the data signal. Namely, in the liquid crystal panel 2, the polarization state of light incident from the backlight 7 through the polarizing plate 6 is modulated by the liquid crystal layer, and the amount of light passing through the polarizing plate 5 to an observer side is controlled, whereby a desired image is displayed.

The backlight 7 includes a plurality of light sources 8, each having a plurality of LEDs as light-emitting elements, arranged on a bottom surface of a bottomed and frame-shaped chassis 9 made of a metal or a resin. In the backlight 7 of the liquid crystal display device 1 according to the present embodiment, each of the light sources 8 has one each of LEDs of three colors of R (red), G (green), and B (blue). Light from the backlight 7 is irradiated onto an irradiation surface on the back surface side of the liquid crystal panel 2. Further, the backlight 7 of the liquid crystal display device 1 of the present embodiment is of an active backlight type that controls the color and luminance of light to be irradiated from each of the light sources 8 based on an image to be displayed on the liquid crystal panel 2, thereby locally changing the color and brightness of light to be irradiated from the backlight 7 onto the back surface side of the liquid crystal panel 2.

As schematically shown in FIG. 1, a plurality of the light sources 8 are arranged on the planar bottom surface of the chassis 9 in the vertical and horizontal directions. The number of the light sources 8 is determined appropriately depending on how much brightness the backlight 7 should have, how finely the coloration and brightness of light to be irradiated onto the irradiation surface of the liquid crystal panel 2 should be controlled as an active backlight, and the like. In the case of a 38-inch television receiver, for example, the number of the light sources 8 may range from several hundred to several thousand.

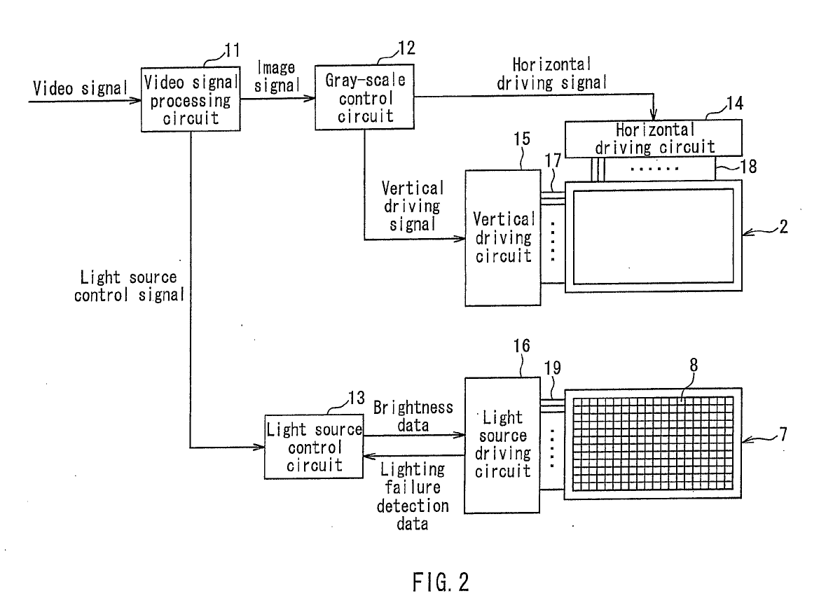

Next, a description will be given of signal processing for image display in the liquid crystal display device 1 of the present embodiment. FIG. 2 is a schematic block diagram showing a configuration of the driving circuit of the liquid crystal display device 1 according to the present embodiment. In the present embodiment, block diagrams are referred to appropriately so as to explain the driving of the backlight. These block diagrams illustrate the driving circuit and the signal processing circuit conceptually plainly. Thus, a circuit formed on one circuit board may be divided functionally and shown as different blocks, and separate hardware such as a circuit configuration may not be necessarily present corresponding to an individual block shown in the block diagrams.

As shown in FIG. 2, a video signal processing circuit 11 generates an image signal and a light source control signal based on an input video signal.

The light source control signal controls the color and luminance of light to be irradiated from the backlight corresponding to the image signal that defines an image to be displayed on the liquid crystal panel 2. In the active backlight type adopted in the present embodiment, light to be irradiated from the light source is controlled corresponding to an image to be displayed on the liquid crystal panel 2. For example, for a portion where a dark image is to be displayed, dim light is irradiated from the light source, or alternatively for a portion where a monochrome image is to be displayed, light to be irradiated from the light source is matched with the color of the display image. Thus, as compared with a conventional backlight that always keeps irradiating an entire display region of a liquid crystal panel with a maximum amount of light, it is possible to reduce the power consumption of the backlight, to improve the contrast of a display image by removing a so-called backlight bleeding, and to display an image with high color purity.

The image signal determines the level of gray-scale to be assigned to each pixel of the liquid crystal panel 2 as a display portion. Namely, the image signal controls transmittance in each pixel. In general, the image signal is provided as the video signal that defines an image to be displayed by the liquid crystal display device 1, and serves as a gray-scale signal for each of sub-pixels of the three RGB colors that compose each pixel of the liquid crystal panel 2. In some cases, the video signal processing circuit 11 subjects the gray-scale signal for each pixel of the liquid crystal panel 2 that is obtained from the video signal to correction in accordance with the color and brightness of light to be irradiated from the backlight 7 onto a display region where the pixel is present, thereby achieving further higher gray-scale image display or further lower power consumption of the backlight 7.

The image signal is input to a gray-scale control circuit 12 and then is divided into a horizontal driving signal and a vertical driving signal so that one image can be displayed by scanning in the vertical and horizontal directions. The horizontal driving signal and the vertical driving signal drive a horizontal driving circuit 14 and a vertical driving circuit 15, respectively. Then, the gray-scale signal for image display is supplied sequentially from the horizontal driving circuit 14 to each pixel of the liquid crystal panel 2 via a data line 18 corresponding to a scanning line 17 that is selected sequentially by the vertical driving circuit 15, thereby forming a display image.

The light source control signal is input to a light source control circuit 13, which then generates a light source driving signal that instructs each of a plurality of the light sources 8 about the color and luminance of light to be irradiated therefrom. In the present embodiment, since each of the light sources 8 has the LEDs of the three RGB colors as light-emitting elements as described above, the light source driving signal instructs each of the RGB LEDs included in each of the light sources 8 about its originally required emission brightness.

The light source control circuit 13 subjects the light source driving signal to brightness correction (which will be described later) according to need, and converts the signal into brightness data. The brightness data, which is a signal that determines actual emission brightness of each of the LEDs as light-emitting elements, is applied to a light source driving circuit 16 as a driver of the LEDs. Then, the light source driving circuit 16 individually controls a voltage or current to be applied to each of the LEDs, and supplies it to each of the LEDs via a connection line 19.

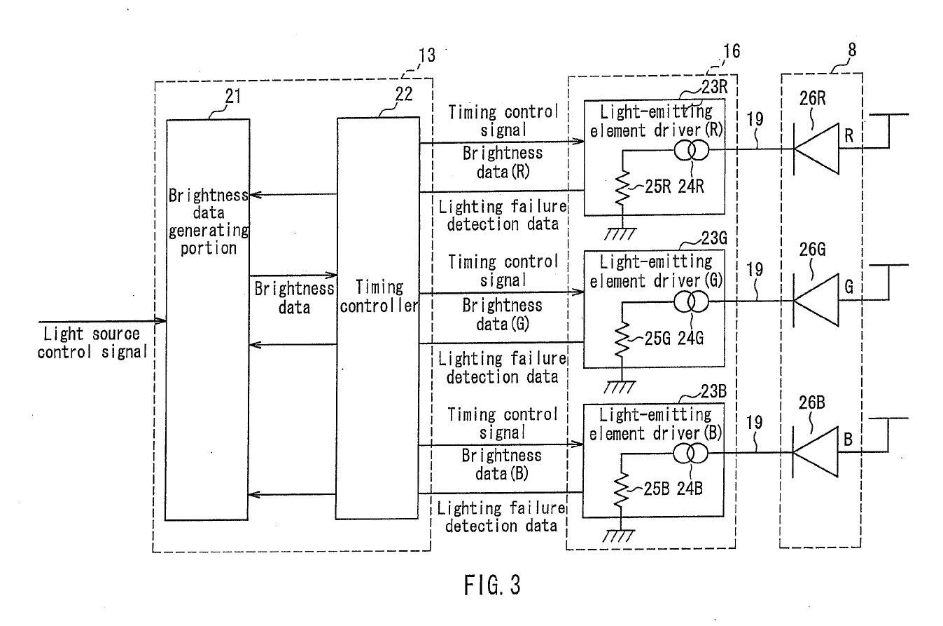

FIG. 3 is a block diagram showing a further detailed configuration of the light source control circuit 13, the light source driving circuit 16, and the light source 8. As shown in FIG. 3, the light source control circuit 13 includes a brightness data generating portion 21 and a timing controller 22, and the light source driving circuit 16 includes light-emitting element drivers 23.

The brightness data generating portion 21 generates the light source driving signal that instructs each of the light sources about the color and luminance of light to be irradiated therefrom, based on the light source control signal generated by the video signal processing circuit 11, and generates emission data that indicates original brightness of light to be emitted from each of the LEDs of the three RGB colors as light-emitting elements included in each of the light sources, in accordance with the instruction of the light source driving signal. Further, when the brightness data generating portion 21 detects that any of the LEDs fails to light properly, it subjects predetermined LEDs to brightness correction according to need, and generates the brightness data that indicates the brightness of each of the LEDs after the brightness correction. The configuration of the brightness data generating portion 21 will be described in detail later.

The brightness of the LEDs basically is controlled by a driving current, and accordingly the brightness data corresponds to numerical data of a current to flow through each of the LEDs. In recent years, in order to avoid a subtle change in the luminescent color of the LEDs that is caused when the driving current to flow through the LEDs varies, the current to flow through the LEDs is subjected to PWM control. In this case, the brightness data also includes a so-called Duty value, which indicates the ratio of the light-emitting time of the LEDs.

The LEDs of the three RGB colors have different current brightness characteristics, and accordingly the brightness data for each color has a value determined in consideration of the characteristics of each of the LEDs. Further, in the case where, for example, one light source has one each of a red (R) LED and a blue (B) LED and two green (G) LEDs, for example, instead of having one each of LEDs of the three RGB colors, the brightness data generating portion 21 generates the brightness data to be supplied to each of the LEDs such that combined light beams irradiated from the four LEDs realize desired color and luminance of light to be irradiated from the light source.

The timing controller 22 outputs the brightness data of the LEDs and a timing control signal for driving each of the LEDs to the light source driving circuit 16, while controlling the timing of transferring the signal. Further, the timing controller 22 controls the timing of receiving lighting failure detection data from the light source driving circuit 16.

The light source driving circuit 16 converts the brightness data into a current value of each of the light-emitting element drivers or a Duty value, thereby driving the light-emitting element drivers. Further, the light source driving circuit 16 controls the timing of each of the light-emitting element drivers by using the timing control signal.

Each of the light-emitting element drivers 23 is a driver circuit for actually driving each of the LEDs based on the input current value and Duty value. In the present embodiment, a light-emitting element driver (R) 23R, a light-emitting element driver (G) 23G, and a light-emitting element driver (B) 23B are provided respectively for a red (R) LED 26R, a green (G) LED 26G, and a blue (B) LED 26b as light-emitting elements included in each of the light sources 8. Although the configuration shown in FIG. 3 covers only a part corresponding to one of the light sources 8, there are the light-emitting element drivers 23 as many as the LEDs 26 included in all the light sources 8.

For example, the light-emitting element driver (R) 23R for the red (R) LED 26R includes a current source 24R as a current control element and a detection resistor 25R for monitoring a current to flow through the LED 26R. Based on the brightness data (R) that defines the brightness of the red (R) LED 23R and the timing control signal, the light-emitting element driver (R) 23R adjusts the current source 24R so as to adjust the value of the current to flow through the LED 26R via the connection line 19, and controls the Duty value of the light-emitting time so as to control the brightness.

Similarly, the light-emitting element driver (G) 23G for the green (G) LED 26G and the light-emitting element driver (B) 23B for the blue (B) LED 26B respectively adjust current sources 24G and 24B and the Duty values in accordance with the brightness data (G) and (B) of the LEDs 26G and 26B and the timing control signals, thereby controlling the emission brightness of the LEDs 26G and 26B.

As described above, the light-emitting element drives 23R, 23G, and 23B adjust the brightness, while monitoring with the detecting resistors 25R, 25G, and 25B the currents to flow through the LEDs 26R, 26G, and 26B to be driven, resepctively. Thus, the detection resistors 25R, 25G, and 25B, which constantly detect the currents to flow through the LEDs, immediately can detect the occurrence of an opening failure and hence a lighting failure of the LEDs. In this manner, the light-emitting element drivers 23R, 23G, and 23B also function as lighting failure detecting portions for the respective LEDs 26R, 26G, and 26B to be driven.

According to the backlight 7 of the present embodiment, the lighting failure detection data of any of the LEDs obtained by constantly monitoring the respective LEDs is fed back to the brightness data generating portion 21, which then subjects other normal LEDs located around the LED that fails to light properly to brightness correction, whereby color irregularity and brightness irregularity of light to be irradiated from the backlight are reduced.

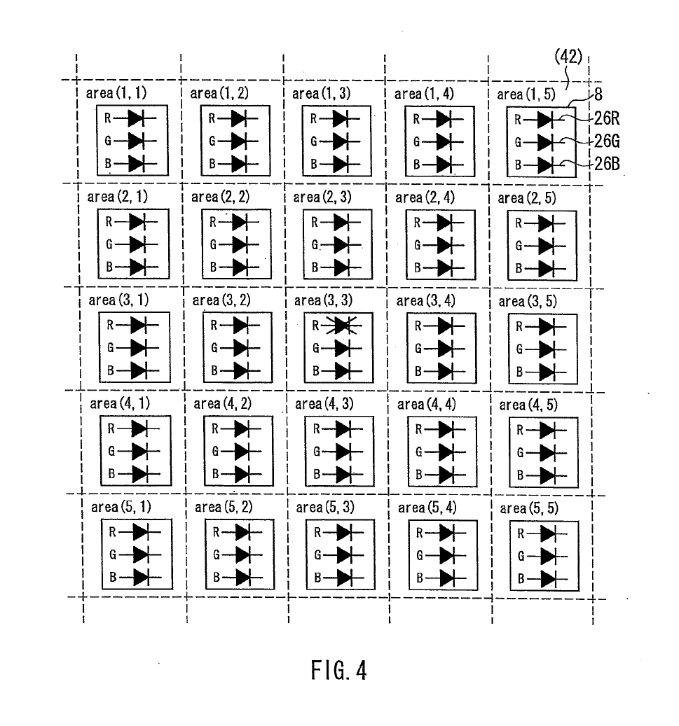

Next, a description will be given of the brightness correction operation performed when any of the LEDs as light-emitting elements fails to light properly in the backlight 7 according to the present embodiment, with reference to FIGS. 4 to 6.

FIG. 4 shows the light sources 8 arranged on the bottom surface of the chassis of the backlight 7 of the present embodiment. In FIG. 4, among a large number of the light sources 8, a total of twenty-five light sources, i.e., five in the vertical direction and five in the horizontal direction, are shown. It is understood that the light sources 8 are arranged further continuously in the upward, downward, leftward and rightward directions in FIG. 4 in addition to the twenty-five light sources shown in FIG. 4. In FIG. 4, each of the twenty-five light sources 8 is indicated by an area (x, y) corresponding to its location. As described above, each of the light sources 8 has the LEDs 26R, 26G, and 26B of the three colors.

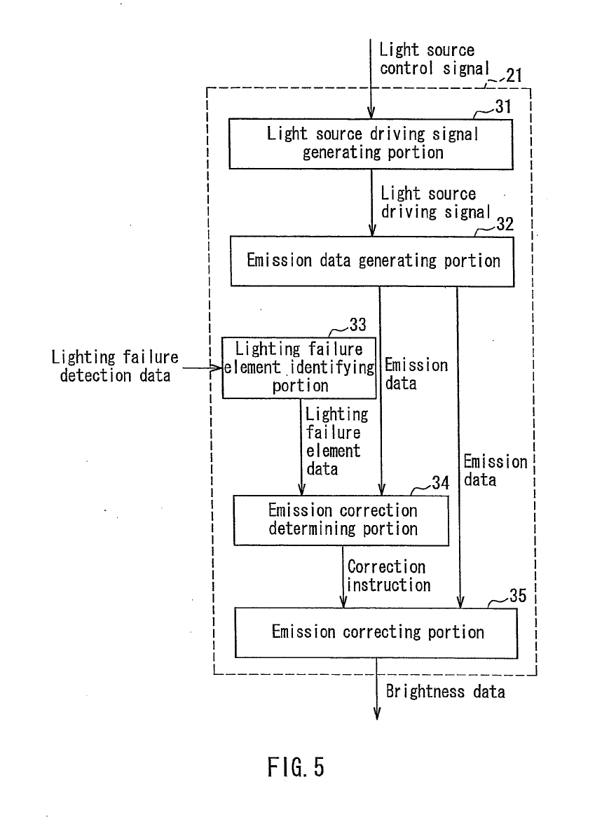

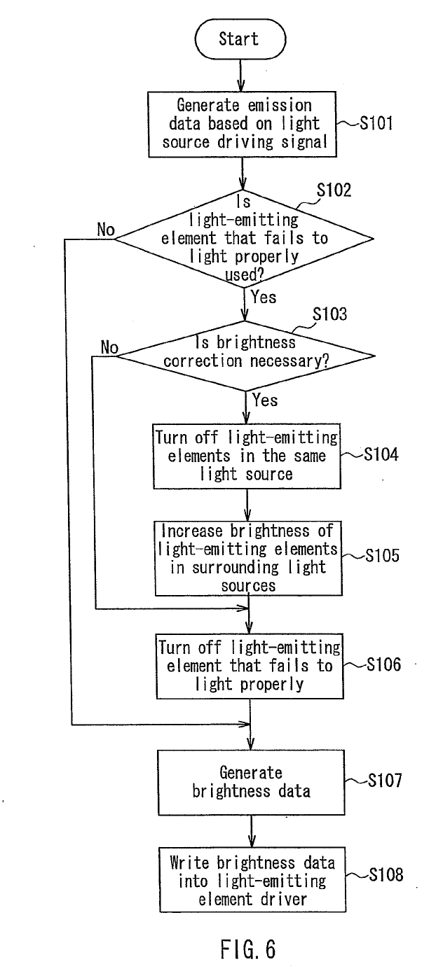

With reference to FIGS. 5 and 6, a description will be given of the brightness correction performed when one of the LEDs fails to light properly in the backlight of the present embodiment, assuming that the LED that fails to light properly is a red (R) LED included in the light source located at a central area (3, 3) among the twenty-five light sources shown in FIG. 4. FIG. 5 is a block diagram showing the configuration of the brightness data generating portion 21 of the backlight according to the present embodiment, and FIG. 6 is a flowchart showing the brightness correction operation for the LEDs in the backlight according to the present embodiment.

As shown in FIG. 5, the brightness data generating portion 21 includes a light source driving signal generating portion 31, an emission data generating portion 32, a lighting failure element identifying portion 33, an emission correction determining portion 34, and an emission correcting portion 35.

The light source driving signal generating portion 31 generates the light source driving signal that instructs the entire backlight as a light source about the color and luminance of light to be irradiated from the respective light sources arranged in the backlight based on the light source control signal that locally defines the color and luminance of light to be irradiated from the backlight. More specifically, in consideration of the timing of displaying an image on the liquid crystal panel and information on the locations of the individual light sources, the light source driving signal generating portion 31 defines light to be irradiated from the respective light sources so as to realize a desired distribution of light to be irradiated from the entire backlight.

Based on the input light source driving signal that defines the color and luminance of light to be irradiated from the respective light sources, the emission data generating portion 32 generates the emission data that indicates the emission brightness of the respective LEDs of the three RGB colors forming each of the light sources so as to allow the light sources to irradiate the desired light.

The lighting failure element identifying portion 33 has a memory function of storing the lighting failure detection data of the LED detected by the light-emitting element driver 23 that also serves as a lighting failure detecting portion and a function of generating lighting failure element data. The lighting failure element identifying portion 33 always grasps which of the LEDs fails to light properly at the present time. The location of the LED that fails to light properly can be specified by using coordinates that indicate the locations of the respective light sources as shown in FIG. 4 or numbers assigned to the respective light sources, and index characters, numbers, or the like that represent the colors of the LEDs, for example. The lighting failure element identifying portion 33 outputs the lighting failure element data that specifies the LED that fails to light properly.

Based on the emission data obtained by the emission data generating portion 32 and the lighting failure element data generated by the lighting failure element identifying portion 33, the emission correction determining portion 34 determines whether or not the emission data obtained from the light source driving signal instructs the LED that fails to light properly to emit light with a brightness higher than a predetermined threshold value. When the LED that fails to light properly is instructed to emit light with a brightness higher than the predetermined threshold value, the emission correction determining portion 34 determines that LEDs other than the LED that fails to light properly need to be subjected to the brightness correction, and instructs the emission correcting portion 35 to perform the brightness correction.

On the other hand, when the emission data obtained from the light source driving signal instructs the LED that fails to light properly to emit light with a brightness not higher than the predetermined threshold value, the emission correction determining portion 34 determines that the normal LEDs other than the LED that fails to light properly need not be subjected to the brightness correction, and does not instruct the emission correcting portion 35 to perform the brightness correction.

Here, the predetermined threshold value is determined within a range that does not have a substantial effect on the color and brightness of light to be irradiated from the light source even if one LED that is instructed to emit light by the emission data fails to light properly. This is because as long as the emission brightness of the LED that is instructed to emit light by the emission data but fails to light properly has no substantial effect on the color and brightness of light to be irradiated from the light source, no problem arises even if this LED fails to emit light. It is understood that in order to prevent color irregularity and brightness irregularity most strictly, this threshold value may be set to a brightness of 0.

The emission correcting portion 35, when instructed to perform the brightness correction by the emission correction determining portion 34, calculates a brightness correction amount for each of the LEDs other than the LED that fails to light properly. Then, the emission correcting portion 35 superimposes the calculated brightness correction amount on the emission data that indicates original emission brightness of each of the LEDs other than the LED that fails to light properly, and outputs the brightness data that indicates the corrected emission brightness of the LEDs.

On the other hand, the emission correcting portion 35, when not instructed to perform the brightness correction by the emission correction determining portion 34, outputs as the brightness data the emission data input from the emission data generating portion 32 as it is.

The above-described processing for generating the brightness data by the brightness data generating portion 21 will be described using the flowchart in FIG. 6.

As shown in FIG. 6, in the first step S101, the emission data generating portion 32 generates the emission data for the respective LEDs included in each of the light sources based on the light source driving signal. As described above, the emission data is a signal that indicates brightness required for each of the LEDs of the three RGB colors included in each of the light sources to realize the color and intensity of light to be irradiated from the light source when none of the LEDs as light-emitting elements fails to light properly. Further, the emission data corresponds to each of the LEDs as light-emitting elements, and includes the information on the location of the light source having the relevant LED.

In the subsequent step S102, the emission correction determining portion 34 determines whether or not the obtained emission data instructs the LED that fails to light properly to emit light. When the LED that fails to light properly is instructed to emit light, in other words, the LED that fails to light properly is used, the process proceeds to the next step S103. On the other hand, when the LED that fails to light properly is not used, the process proceeds to S107.

When the LED that fails to light properly is used, i.e., in the case of Yes in S102, the emission correction determining portion 34 determines whether or not the emission data instructs the LED that fails to light properly to emit light with a brightness higher than the preset threshold value. When the emission brightness instructed for the LED that fails to light properly is higher than the preset threshold value, the emission correction determining portion 34 determines that the brightness correction is necessary (Yes). In this case, the process proceeds to the next step S104. On the other hand, when the emission brightness instructed for the LED that fails to light properly is lower than the preset threshold value, the emission correction determining portion 34 determines that the brightness correction is unnecessary (No), and the process proceeds to S106.

This processing for determining the necessity of the correction by the emission correction determining portion 34 is performed based on the emission data obtained by the emission data generating portion 32 and the lighting failure element data generated by the lighting failure element identifying portion 33. The lighting failure element data also includes the information on the light source having the LED that fails to light properly, i.e., the information on the location of the light source.

A specific example of determining the emission correction by the emission correction determining portion 34 will be described with reference to FIG. 4. In the example in FIG. 4, the red (R) LED included in the light source located at the area (3, 3) fails to light properly. This is detected by the light-emitting element driver 23 as a lighting failure detecting portion for this red LED and transmitted as the lighting failure detection data.

For example, in the case where light to be irradiated from the light source at the area (3, 3) is white light with a maximum brightness, the emission data instructs all the LEDs of the three RGB colors included in the light source at the area (3, 3) to emit light such that light beams irradiated from the LEDs of the three colors in total form white light with a maximum brightness. In this case, the emission data instructs the red (R) LED that fails to light properly to emit light with an emission brightness higher than the preset threshold value. Accordingly, in this case, the emission correction determining portion 34 determines that the brightness correction is necessary, and instructs the emission correcting portion 35 to perform the correction.

On the other hand, in the case where light to be irradiated from the light source located at the area (3, 3) is cyan light that can be expressed only by monochromatic light beam emitted from the green (G) or blue (B) LED or monochromatic light beams emitted from the green (G) and blue (B) LEDs, the emission data instructs the red (R) LED not to light (i.e., to emit light with a brightness of 0). Further, there are cases where the red (R) LED is required to emit light only with a very low brightness, such as the case where light to be irradiated from the light source located at the area (3, 3) is white light with an extremely low irradiation brightness. As described above, in the case where the emission data instructs the red (R) LED that fails to light properly not to light (brightness: 0) or to emit light with a slight brightness, even if the red LED that fails to light properly does not emit light, this has only a substantially negligible effect on light to be irradiated from the light source. Thus, when the LED that fails to light properly is instructed to emit light with a brightness not higher than the threshold value, which is defined as a level negligible even if the LED that fails to light properly does not emit light, the emission correction determining portion 34 determines that the brightness correction is unnecessary.

When it is determined in S103 that the brightness correction is necessary (Yes), in the next step S104, the emission correcting portion 35 generates, for the other LEDs included in the light source having the LED that fails to light properly, i.e., the green (G) LED and the blue (B) LED at the area (3, 3), non-lighting data that instructs these LEDs not to light, in other words, to emit light with a brightness of 0.

Next, in S105, the emission correcting portion 35 generates, for the LEDs included in other light sources that are located around the light source at the area (3, 3) having the LED that fails to light properly, brightness superimposition data that instructs these LEDs to emit light with a higher brightness. The brightness superimposition data is determined in accordance with the color and intensity of light that should have been irradiated from the light source at the area (3, 3) having the LED that fails to light properly.

When the LED that fails to light properly is used, in S106, the emission correcting portion 35 generates the non-lighting data as the brightness data for the LED that fails to light properly. This makes it possible to deal with the case where, for example, a plurality of the LEDs are connected in series and controlled collectively.

In S107, the emission correcting portion 35 generates the brightness data that indicates actual brightness of light to be emitted from the respective LEDs based on the non-lighting data obtained in S104 above and the brightness superimposition data obtained in S105. Namely, the emission correcting portion 35 generates, for the other LEDs included in the light source having the LED that fails to light properly, the brightness data that instructs these LEDs not to light, whatever the emission data that indicates original brightness of light to be emitted from the LEDs. For the LEDs included in the light sources that are located around the light source having the LED that fails to light properly, the emission correcting portion 35 generates the brightness data that is obtained by superimposing the brightness superimposition data on the emission data that indicates brightness originally required for the respective LEDs.

On the other hand, when it is determined in S103 that the brightness correction is unnecessary (No), the emission correcting portion 35 generates, for the other LEDs located in the vicinity of the LED that fails to light properly, the emission data that instructs the respective LEDs to emit light with an original emission brightness, as the brightness data of the LEDs. Here, the other LEDs located in the vicinity of the LED that fails to light properly refer to both the other LEDs included in the light source having the LED that fails to light properly and the LEDs that are adjacent to the light source having the LED that fails to light properly and are subjected to the brightness correction by the superimposition in S105 when the correction is determined to be necessary

In S108, the brightness data generated by the brightness correcting portion 35 is transmitted to the light-emitting element drivers 23R, 23G, and 23B via the timing controller 22, so that the respective LEDs light accordingly.

Again, the brightness correction shown in FIG. 6 will be described specifically with reference to FIG. 4.

It is assumed that the LEDs included in respective eight light sources located at areas (2, 2), (2, 3), (2, 4), (3, 2), (3, 4), (4, 2), (4, 3), and (4, 4) adjacent to the light source at the area (3, 3) having the LED that fails to light properly are subjected to the brightness correction. Further, it is assumed that in order to irradiate white light, the LEDs of the three colors in each of the light sources respectively have the following brightness data: red (R)=100, green (G)=100, and blue (B)=100. As described above, the brightness data is a current value or a Duty value of the light-emitting time that is determined in consideration of the characteristics of each of the RGB LEDs. Further, it is assumed that the brightness correction amount for each of the LEDs included in the above-described eight light sources located around the area (3, 3) is 30%.

In this case, initially, the emission correcting portion 35 generates, for the green (G) LED and the blue (B) LED included in the light source located at the area (3, 3), the brightness data that instructs these LEDs not to light. Further, the emission correcting portion 35 supplies the respective red (R), green (G), and blue (B) LEDs included in each of the eight light sources located at the areas (2, 2), (2, 3), (2, 4), (3, 2), (3, 4), (4, 2), (4, 3), and (4, 4), which are subjected to the brightness correction, with the brightness data that instructs these LEDs to emit light with a brightness of 130 (100+100×0.3).

In the above-described example, which is based on the assumption that the respective light sources irradiate white light with the same brightness, the brightness data that defines the corrected brightness of the LEDs has the same current value for the LEDs of the same color included in all the eight light sources located at the areas (2, 2), (2, 3), (2, 4), (3, 2), (3, 4), (4, 2), (4, 3), and (4, 4). However, in the case where the LEDs of the same color included in the respective eight surrounding light sources at the areas (2, 2), (2, 3), (2, 4), (3, 2), (3, 4), (4, 2), (4, 3), and (4, 4), which are subjected to the brightness correction, are instructed by the emission data to emit light with different brightnesses, the brightness correcting portion 34 supplies the respective LEDs with the brightness data that is obtained by superimposing the correction amount on their original brightnesses. Thus, it is understood that the respective LEDs have different emission brightnesses.

Further, in the above-described example, the correction amount in the light sources to be subjected to the brightness correction is 30%. However, this numerical value may be set appropriately within a range in which brightness irregularity of irradiated light that occurs when all the LEDs included in the light source having the LED that fails to light properly are turned off and hence the light source itself does not light can be made less noticeable.

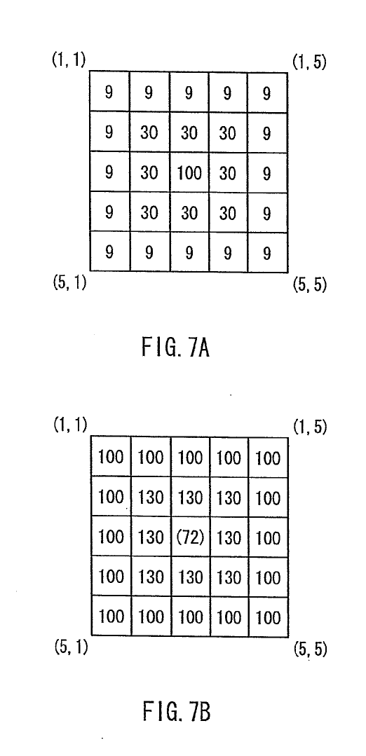

Hereinafter, a description will be given of how to determine the brightness correction amount, with reference to FIGS. 7A and 7B.

FIG. 7A shows an illumination distribution on a virtual irradiation surface opposed to the light sources that is achieved by light to be irradiated from one of the light sources. In the present embodiment, since the lighting device according to the present invention is used as a backlight, the virtual irradiation surface actually corresponds to the surface on the back surface side of the liquid crystal panel opposed to the backlight. In FIG. 7, it also is assumed that a total of twenty-five light sources, i.e., five in the vertical direction and five in the horizontal direction, are arranged as in FIG. 4 and that the coordinates of the respective light sources are indicated in the same manner as in FIG. 4. Also, it is assumed that the irradiation surface opposed to each of the light sources is indicated by the same coordinates as those used for the light source. For the sake of simplicity, FIGS. 7A and 7B show only four coordinates (1, 1), (1, 5), (5, 1), and (5, 5) respectively located at four corners.

It is assumed that as shown in FIG. 7A, when the light source located at the central area (3, 3) lights with an emission brightness of 100, a central region (3, 3) on the opposed irradiation surface has a luminance corresponding to a brightness of 100. At this time, assuming that 30% of irradiated light leaks into regions opposed to the adjacent light sources, even if the other light sources do not light, regions (2, 2), (2, 3), (2, 4), (3, 2), (3, 4), (4, 2), (4, 3), and (4, 4) that are adjacent to the central region (3, 3) on the opposed surface and are opposed respectively to eight light sources have an illuminance corresponding to an emission brightness of 30 (100×0.3) of the light sources due to the leaking light irradiated from the central light source. Further, on the virtual opposed surface, regions (1, 1), (1, 2), (1, 3), (1, 4), (1, 5), (2, 1), (2, 5), (3, 1), (3, 5), (4, 1), (4, 5), (5, 1), (5, 2), (5, 3), (5, 4), and (5, 5) that are further adjacent to the above eight regions and are opposed respectively to sixteen light sources have an illuminance corresponding to a brightness of 9 (100×0.3×0.3) of the light sources.

Therefore, even if the light source located at the central area (3, 3) fails to light properly, allowing no light to be irradiated therefrom, when the illuminance in the regions (2, 2), (2, 3), (2, 4), (3, 2), (3, 4), (4, 2), (4, 3), and (4, 4) that is achieved by light to be irradiated from the respective eight opposed light sources adjacent to the central light source is adjusted to 130 by superimposing a correction amount of 30%, the region (3, 3) opposed to the central light source is allowed to have an illuminance of 72 (30×0.3×8) corresponding to the correction amount, as shown in FIG. 7B.

As described above, the illuminance in the region opposed to the light source that does not light can be regarded as the sum of leaking light irradiated from the adjacent light sources. Thus, by determining the illuminance required for the region on the surface opposed to the light source that does not light, it is possible to determine the brightness superimposition amount for the light sources adjacent to the light source that does not light.

In the above-described example, the light source having the LED that fails to light properly and the adjacent eight light sources are subjected to the brightness correction. However, the present invention is not limited thereto. The brightness correction also may be performed for sixteen light sources at further surrounding areas (1, 1), (1, 2), (1, 3), (1, 4), (1, 5), (2, 1), (2, 5), (3, 1), (3, 5), (4, 1), (4, 5), (5, 1), (5, 2), (5, 3), (5, 4), and (5, 5).

In particular, in the case of performing the brightness correction extensively for the light sources that surround the light source that does not light doubly or more, the brightness correction amount to be superimposed preferably is decreased with increasing distance from the light source that does not light. For example, in FIG. 4, in the case of performing the brightness correction for all the twenty-four light sources surrounding the area (3, 3) shown in the figure, the correction ratio for the light sources at the eight areas (2, 2), (2, 3), (2, 4), (3, 2), (3, 4), (4, 2), (4, 3), and (4, 4) adjacent to the light source at the area (3, 3) that does not light may be 30%, and the correction ratio for the sixteen light sources located at the outer areas (1, 1), (1, 2), (1, 3), (1, 4), (1, 5), (2, 1), (2, 5), (3, 1), (3, 5), (4, 1), (4, 5), (5, 1), (5, 2), (5, 3), (5, 4), and (5, 5) may be 9%. This makes it possible to reduce a brightness difference between light to be irradiated from the light sources that are subjected to the brightness correction and light to be irradiated from the light sources at outer locations that are not subjected to the brightness correction, resulting in a brightness distribution with a smooth difference and hence a further uniform distribution of irradiated light.

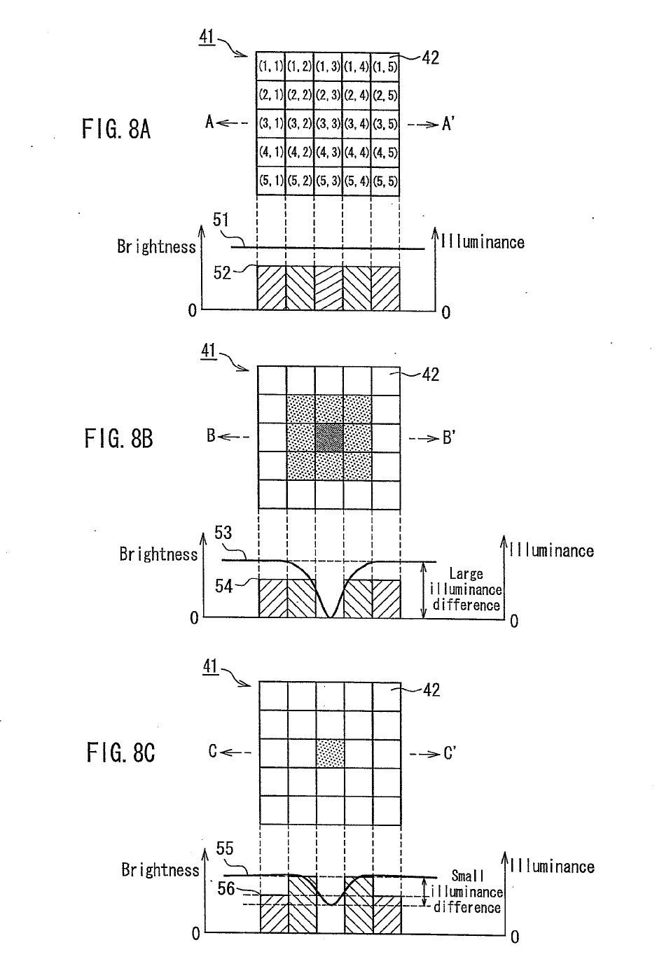

Next, a description will be given of an effect to be achieved by the brightness correction, with reference to FIG. 8.

FIGS. 8A to 8C are image views illustrating that the above-described brightness correction can eliminate a brightness variation of irradiated light in the backlight of the present embodiment that occurs when all the LEDs included in the light source having the LED that fails to light properly are tuned off and hence the light source itself does not light.

In each of FIGS. 8A, 8B, and 8C, the upper part shows, as FIGS. 7A and 7B, an illuminance distribution on a virtual irradiation surface 41 that is achieved by light to be irradiated from a total of twenty-five light sources, i.e., five in the vertical direction and five in the horizontal direction, as shown in FIG. 4. As described above, in the present embodiment, since the lighting device according to the present invention is used as a backlight, the virtual irradiation surface 41 actually corresponds to the surface on the back surface side of the liquid crystal panel opposed to the backlight. Further, it is assumed that the virtual irradiation surface 41 also is defined by the same type of position coordinates as that used for indicating the area where each corresponding light source is arranged. Namely, the light source arranged at the area (1, 1) in FIG. 4 is opposed to a fine region (1, 1) on the irradiation surface shown in FIG. 8A.

The lower part in each of FIGS. 8A, 8B, and 8C shows illuminance 51, 53, or 55 in central regions (3, 1) to (3, 5) along a line A-A′, a line B-B′, or a line C-C′ among twenty-five fine regions on the irradiation surface shown in the upper part, and brightness 52, 54, or 56 of light to be irradiated from the corresponding light sources. The brightness 52, 54, or 56 of light to be irradiated from each of the light sources is indicated by a bar graph, and the illuminance 51, 53, or 55 on the irradiation surface is indicated by a line graph. It is assumed that both the brightness and the illuminance shown in the lower part in each of FIGS. 8A to 8C have a higher value, i.e., indicate higher lightness, on an upper side of the figure. However, the lightness is not given an absolute value but given in relative magnitude. Further, as described with reference to FIG. 4, it is assumed that the respective light sources irradiate white light with the same brightness.

FIG. 8A shows the case where all the relevant twenty-five (5×5) light sources do not have an LED that fails to light properly and irradiate white light as instructed by the emission data. As shown in the upper part, all fine regions 42 on the irradiation surface 41 are irradiated with uniform white light. Namely, the five fine regions along the line A-A′ shown in the lower part are irradiated with light with the uniform brightness 52, and the opposed five fine regions (3, 1) to (3, 5) have the constant luminance 51.

FIG. 8B shows the case where the light source located at the central area (3, 3) has an LED that fails to light properly, and all the LEDs included in the central light source are turned off, i.e., the central light source itself does not light. As indicated by a distribution of the brightness 54 of light from the light sources shown in the lower part in FIG. 7B, the brightness of light from the light source located at the area (3, 3) is 0. At this time, as shown in the upper part in FIG. 8B, the fine region (3, 3) on the irradiation surface 41 opposed to the light source that does not light is dark, and eight surrounding fine regions (2, 2), (2, 3), (2, 4), (3, 2), (3, 4), (4, 2), (4, 3), and (4, 4) also suffer lower brightness due to decreased irradiated light caused by the light source that does not light. In this case, as shown in the lower part, the illuminance 53 in the fine regions along the line B-B′ is distributed such that the illuminance in the fine region (3, 3) opposed to the central light source falls significantly, varying greatly from the illuminance in the other regions opposed to the light sources that light normally.

FIG. 8C shows the case where the brightness correction is performed by the brightness correcting portion of the backlight according to the present embodiment. More specifically, the light sources located at the eight areas (2, 2), (2, 3), (2, 4), (3, 2), (3, 4), (4, 2), (4, 3), and (4, 4) surrounding the light source at the central area (3, 3) having the LED that fails to light properly are subjected to the brightness correction to have increased brightness. In this case, as shown in the upper part in FIG. 8C, although the illuminance decreases in the central fine region (3, 3), the illuminance on the irradiation surface is distributed with a smaller difference across the regions because the light sources located around the light source that does not light have increased brightness. This is also apparent from a distribution of the brightness 56 of the respective light sources shown in the lower part. Although the light source at the central area (3, 3) that does not light has a brightness of 0, the two adjacent light sources located at the areas (3, 2) and (3, 4) have brightness higher than that of the further adjacent light sources at the outer areas (3, 1) and (3, 5) that irradiate light with a normal brightness. As a result of this brightness correction, as can be seen from a distribution of the illuminance 55 in the regions along the line C-C′ on the irradiation surface, the illuminance decrease in the fine region (3, 3) opposed to the central light source that does not light becomes smaller than that in FIG. 8B.

In this manner, the illuminance difference on the irradiation surface that occurs when one of the light sources does not light can be made smaller as a whole by increasing the brightness of the light sources located around the light source that does not light. Therefore, it is possible to reduce brightness irregularity of irradiated light that occurs when one of the light sources does not light.

As described above, in the backlight 7 according to the present embodiment, when an LED as a light-emitting element included in one of the light sources fails to light properly, the emission correction determining portion 34 determines whether or not the LED that fails to light properly is instructed to emit light with a brightness not lower than the predetermined threshold value based on the light source driving signal. Then, when the LED that fails to light properly is instructed to emit light with a brightness not higher than the predetermined threshold value, the emission correction determining portion 34 does not instruct the emission correcting portion 35 to perform the correction. Thus, other LEDs located in the vicinity of the LED that fails to light properly, which include other LEDs included in the light source having the LED that fails to light properly as well as LEDs included in the surrounding light sources, are not subjected to the brightness correction, so that these LEDs are allowed to light based on the emission data determined in accordance with a display image as the brightness data.

This makes it possible to utilize light to be emitted from the LEDs that light properly, allowing the backlight to irradiate light effectively, and to reduce color irregularity and brightness irregularity of light to be irradiated from the light sources within a range that does not cause a practical problem, as compared with a conventional backlight in which the other LEDs included in the light source having the LED that fails to light properly always are turned off.

On the other hand, when the LED that fails to light properly is instructed to emit light with a brightness higher than the predetermined threshold value by the light source driving signal, the emission correction determining portion 34 instructs the emission correcting portion 35 to perform the correction. Thus, the emission correcting portion 35 turns off the other LEDs included in the light source having the LED that fails to light properly. This makes it possible to prevent color irregularity of irradiated light that occurs when an LED that irradiates light of a specific color in one light source does not light. Further, in this case, the emission correcting portion 35 outputs, to the LEDs included in other light sources located around the light source that does not light, the brightness data that instructs these LEDs to emit light with a corrected brightness, i.e., a brightness increased at a ratio that allows these LEDs to irradiate light of a color that originally should have been irradiated from the light source that does not light. This makes it possible to reduce brightness irregularity of light to be irradiated from the light sources that occurs when one of the light sources does not light. As a result, it is possible to reduce or eliminate effectively both color irregularity and brightness irregularity of irradiated light that occur when an LED that forms the light sources fails to light properly.

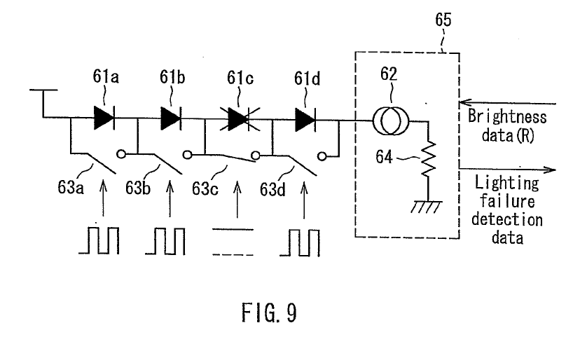

The following description is directed to a modification of the backlight 7 according to the present embodiment, with reference to FIG. 9. FIG. 9 shows a wiring configuration of LEDs included in light sources of the backlight 7 according to the modification of the present embodiment. The part shown in FIG. 9 corresponds to the light-emitting element drivers 23 and the LEDs 26 in FIG. 3.

As described above, the backlight 7 according to the present embodiment may have the light sources on the order of several thousand. Further, when each of the light sources includes LEDs of the three RGB colors, for example, an extremely huge number of LEDs, i.e., three times the number of the light sources, are required. Thus, providing all the LEDs with respective light-emitting element drivers results in an unnecessary cost increase. To avoid this, LEDs of the same color included in a plurality of the light sources located close to each other usually are connected in series, so that these LEDs are driven by one current control element. This can be realized because in many cases, LEDs of the same color arranged adjacent to each other emit light at a substantially similar level since a display image generally has similar color and brightness in adjacent regions.

In the example shown in FIG. 9, four LEDs 61a to 61d of the same luminescent color included in different light sources are connected in series, and one current source 62 is connected to these four LEDs 61a to 61d. The current source 62 and a detecting resistor 64 form a light-emitting element driver 65. As a driving circuit of the backlight 7, it is practically preferable to connect a plurality of the LEDs in series and control them by the one current source as a current control element as described above, because this makes it possible to reduce the number of the current control elements for driving the LEDs as light-emitting elements.

However, in the case of connecting a plurality of the LEDs in series, when one of the LEDs is open and fails to light properly, a current does not flow therethrough, so that all the connected LEDs cannot light. To avoid this, as shown in FIG. 9, the LEDs 61a to 61d respectively have bypass lines in parallel via switching elements 63a to 63d. When one of the LEDs fails to light properly, the switching element corresponding to the LED that fails to light properly is turned on, so that a driving current is bypassed to the bypass line. In the case of FIG. 8 where the LED 6c fails to light properly, the switch 63c is turned on, so that the current flows through the bypass line in this portion. Thus, the other three LEDs 61a, 61b, and 61d can light normally.

As shown in FIG. 9, in the case of connecting a plurality of the LEDs in series, the one detecting resistor 64 is provided to monitor the current source to see whether it is functioning normally. When the detecting resistor 64 finds that no current is flowing through the serially joined LEDs, the light source driving circuit 16 immediately assumes an opening failure detection mode, thereby identifying which of the LEDs 61a to 61d has an opening failure. In this manner, also in the case of connecting a plurality of the LEDs in series, the lighting failure detection data that identifies the LED that is open and fails to light properly can be output from the light-emitting element driver 65 as a lighting failure detecting portion to the lighting failure element identifying portion 33, followed by the above-described brightness correction.

In the above description, in the backlight 7 according to the embodiment of the present invention, each of the light sources has one each of LEDs of three RGB colors as light-emitting elements. However, the present invention is not limited thereto. The luminescent color of each of the LEDs included in the light source is selected appropriately depending on light to be irradiated from the light source. Further, as for the case where the LEDs of the three RGB colors are used to realize a white light source, it is not necessarily required that each of the light sources includes the LEDs of the respective colors in equal numbers as described above. The above-described concept of the brightness correction according to the present embodiment also can be applied to the case where each of the light sources has two LEDs of the same color and one of them fails to light properly, which results in the effect of reducing color irregularity and brightness irregularity of irradiated light. Further, in the case where each of the light sources has two or more LEDs of the same color and one of them fails to light properly, when brightness required for this color can be obtained by increasing the brightness of the other LED of the same color, it is of course unnecessary to turn off the LEDs of other colors included in this light source.

In the above-described embodiment, the description is directed to the case where only one of the LEDs included in one of the light sources fails to light properly. However, the concept of the brightness correction according to the present embodiment also can be applied to the case where two or more of the LEDs included in one of the light sources fail to light properly, which results in the effect of reducing color irregularity and brightness irregularity of light to be irradiated from the backlight 7.

According to the present embodiment, the LEDs included in the light sources around the light source that does not light are subjected to the brightness correction depending on color and intensity of light that should have been irradiated from the light source that does not light. This concept also can be applied to the case where, for example, adjacent light sources have an LED that fails to light properly, which results in the effect of reducing color irregularity and brightness irregularity of light to be irradiated from the light sources having the LED that fails to light properly at the same time.

Further, also in the case where color and intensity of irradiated light are kept constant unlike the present embodiment where the lighting device is used as an active backlight, it is of course possible to achieve the effect of reducing brightness irregularity that occurs when the light source having the LED that fails to light properly does not light.

Further, in the above-described present embodiment, the LEDs are used as light-emitting elements for use in a light source device. However, the present invention is not limited thereto, and light-emitting elements such as an EL light source and other fluorescent lamps also may be used.

Further, the above description is directed to the example where the light source device is used as a backlight of a liquid crystal display device. However, the light source device according to the present embodiment, which is a thin lighting device that can irradiate light of uniform color and brightness and can change the color and brightness of irradiated light locally, have a wide range of uses such as a lighting device to be embedded in a ceiling or wall surface and a lighting device for use in a showcase and the like.

### INDUSTRIAL APPLICABILITY

The present invention is applicable industrially as a lighting device that is less likely to cause color irregularity and brightness irregularity of light to be irradiated from a plurality of light sources even if a light-emitting element forming the light sources fails to light properly, and as a display device using this lighting device as a backlight for a display portion.

1. A lighting device that includes a plurality of light sources, each having a plurality of light-emitting elements of different luminescent colors, arranged on a plane, and can control color and luminance of light to be irradiated from the light sources by controlling brightness of each of the light-emitting elements based on a light source driving signal,
the device comprising:
a lighting failure detecting portion that detects which of the light-emitting elements fails to light properly;
an emission correction determining portion that determines the necessity of brightness correction for the light-emitting elements other than the light emitting element that fails to light properly, based on a level of the brightness instructed for the light-emitting element that fails to light properly by the light source driving signal; and
an emission correcting portion that performs the brightness correction for the other light-emitting elements in accordance with the determination made by the emission correction determining portion.

2. The lighting device according to claim 1,
wherein when the level of the brightness instructed for the light-emitting element that fails to light properly by the light source driving signal is not higher than a predetermined threshold value,
the emission correction determining portion determines that it is unnecessary to perform the brightness correction for the other light-emitting elements, and
the emission correcting portion does not perform the brightness correction for the other light-emitting elements.

3. The lighting device according to claim 1,
wherein when the level of the brightness instructed for the light-emitting element that fails to light properly by the light source driving signal is higher than a predetermined threshold value,
the emission correction determining portion determines that it is necessary to perform the brightness correction for the other light-emitting elements, and
the emission correcting portion turns off the light-emitting elements other than the light-emitting element that fails to light properly in one of the light sources that has the light-emitting element that fails to light properly, and performs the brightness correction for the light-emitting elements included in the other light sources located around the light source having the light-emitting element that fails to light properly.

4. The lighting device according to claim 3, wherein the emission correcting portion performs the brightness correction for the light-emitting elements included in the other light sources located around the light source having the light-emitting element that fails to light properly by superimposing a brightness component for the light-emitting elements of respective colors at a ratio that allows these light-emitting elements to irradiate light of the same color as that of light to be irradiated from the light source having the light-emitting element that fails to light properly.

5. The lighting device according to claim 4, wherein the emission correcting portion performs the brightness correction for the light-emitting elements included in the other light sources located around the light source having the light-emitting element that fails to light properly such that the brightness component to be superimposed is decreased with increasing distance between the other light sources and the light source having the light-emitting element that fails to light properly.

6. The lighting device according to claim 2, wherein the predetermined threshold value is a brightness of 0.

7. The lighting device according to claim 1, wherein the light-emitting elements included in each of the light sources include a red light-emitting element, a green light-emitting element, and a blue light-emitting element.

8. The lighting device according to claim 1, wherein the light-emitting elements are light-emitting diodes.

9. The lighting device according to claim 1, wherein a plurality of at least a part of the light-emitting elements of the same luminescent color included in a plurality of the light sources are connected in series and driven by one current control element.

10. A display device including a display portion,
wherein the display portion is irradiated with light from the lighting device according to claim 1.
